(19) United States
(12) Patent Application Publication
(10) Pub. No.: US 2023/0112216 A1
(43) Pub. Date: Apr. 13, 2023

(54) Insert with adjustable sizes and method of use

(71) Applicant: Yorli Huff, Naperville, IL (US)

(72) Inventor: Yorli Huff, Naperville, IL (US)

(21) Appl. No.: 18/045,289

(22) Filed: Oct. 10, 2022

Related U.S. Application Data
(60) Provisional application No. 63/262,282, filed on Oct. 8, 2021.

(51) Int. Cl. A41D 27/06

(52) U.S. Cl. CPC A41D 27/06

(57) ABSTRACT

This invention relates to a new way to internally frame an article, which can be a t-shirt, a tank top, a pair of pants, a scarf, a hat, or any other type of fabric, during the dye sublimation process, to allow for unbroken transfer of dye.

### CROSS REFERENCE

This application is an original, non-provisional, utility application that claims priority to the provisional application, with application No. 63/262,282, filed on 8 Oct. 2021. This non-provisional application is being filed in a timely manner on 10 Oct. 2022, as 8 Oct. 2022 was a Saturday.

### BRIEF DESCRIPTION OF DRAWINGS

Non-limiting and non-exhaustive examples of several of the various embodiments of the present invention are described with references to the following figures, and reference numbers refer to the same features throughout the various views and embodiments unless otherwise specified.

FIG. 1 is a front view of an embodiment of the thin insert, showing the formed piece of the thin insert.

FIG. 2 is the rear perspective view of an embodiment of the thin insert, showing the showing the adjustable frame which is the shape of a t-shirt and that which is formed by attaching at least one scalable body portion, at least two scalable limb portions, and an arm pit expander.

FIG. 3 is an exploded view of an embodiment of the thin insert, showing the manner in which, separable pieces are attached to put together a formed piece of the thin insert. This embodiment could also be that of an adjustable frame which is formed by joining at least one scalable body portion and at least two scalable limb portions with a tongue and groove joint, and that which can be incorporated in the dye sublimation process.

FIG. 4 is an exploded view of a portion of FIG. 3, showing an embodiment in which the tongues on the edges of the scalable limb portions of the adjustable frame/left and right lateral side portions of the insert fit with the grooves on the edges of the scalable body portion of the adjustable frame/formed piece, to form an adjustable frame/thin insert which can be incorporated in the dye sublimation process.

FIG. 5 is an example illustration showing the fully assembled thin insert or an adjustable frame, fitting into an article, which in this case is a t-shirt.

Corresponding reference characters indicate corresponding components throughout the several views of the drawings. Skilled artisans will appreciate that elements in the figures are illustrated for simplicity and clarity and have not necessarily been drawn to scale. Also, common but well-understood elements that are useful or necessary in a commercially feasible embodiment are often not depicted in order to facilitate a less obstructed view of these various embodiments. Additionally, the disclosed architecture is sufficiently configurable, such that it may be utilized in ways other than what is shown.

### DETAILED DESCRIPTION OF INVENTION

In this Specification, which includes the figures, claims, and this detailed description, reference is made to particular and possible features of the embodiments of the invention, including method steps. These particular and possible features are intended to include all possible combinations of such features, without exclusivity. For instance, where a feature is disclosed in a specific embodiment or claim, that feature can also be used, to the extent possible, in combination with and/or in the context of other aspects and embodiments of the invention, and in the invention generally. Additionally, the disclosed architecture is sufficiently configurable, such that it may be utilized in ways other than what is shown.

The purpose of the Abstract of this Specification is to enable the U.S. Patent and Trademark Office and the public generally, and especially the scientists, engineers and practitioners of the art who are not familiar with patent or legal terms or phrasing, to determine quickly from a cursory inspection the nature and essence of the technical disclosure of the application. The Abstract is not intended to be limiting as to the scope of the invention in any way.

In the following description, numerous specific details are given in order to provide a thorough understanding of the present embodiments. It will be apparent, however, to one having ordinary skill in the art, that the specific detail need not be employed to practice the present embodiments. On other instances, well-known materials or methods have not been described in detail in order to avoid obscuring the present embodiments. When limitations are intended in this Specification, they are made with expressly limiting or exhaustive language.

Reference throughout this Specification to “one embodiment”, “an embodiment”, “one example” or “an example” means that a particular feature, structure, or characteristic described in connection with the embodiment or example is included in at least one embodiment of the present embodiments. Thus, appearances of the phrases “in one embodiment”, “according to an embodiment”, “in an embodiment”, “one example”, “for example”, “an example”, or the like, in various places throughout this Specification are not necessarily all referring to the same embodiment or example. Furthermore, the particular features, structures, or characteristics may be combined in any suitable combinations and/or sub-combinations in one or more embodiments or examples.

The terms “comprises”, “comprising”, “includes”, “including”, “has”, “having”, “could”, “could have” or their grammatical equivalents, are used in this Specification to mean that other features, components, materials, steps, etc. are optionally present as a non-exclusive inclusion. For instance, a device “comprising” (or “which comprises”) components A, B, and C can contain only components A, B, and C, or can contain not only components A, B, and C but also one or more other components. For example, a method comprising two or more defined steps can be carried out in any order or simultaneously, unless the context excludes that possibility; and the method can include one or more other steps which are carried out before any of the defined steps, between two of the defined steps, or after all the defined steps, unless the context excludes that possibility.

Further, unless expressly stated to the contrary, “or” refers to an inclusive or and not to an exclusive or. For example, An embodiment could have optional features A, B, or C, so the embodiment could be satisfied with A in one instance, with B in another instance, and with C in a third instance, and probably with AB, AC, BC, or ABC if the context of features does not exclude that possibility.

Examples or illustrations given are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these example or illustrations are utilized will encompass other embodiments, which may or may not be given in this Specification, and all such embodiments are intended to be included within the scope of that term or terms. Language designating such nonlimiting examples and illustrations includes, but is not limited to “for example”, “for instance”, “etc.”, “or otherwise”, and “in one embodiment.”

The phrase “at least” followed by a number is used to denote the start of a range beginning with that number, which may or may not be a range having an upper limit, depending on the variable defined. For instance, “at least 1” means 1 or more.

In this specification. “a” and “an” and similar phrases are to be interpreted as “at least one” and “one or more.” In this specification, the term “may” or “can be” or “could be” is to be interpreted as “may, for example.” In other words, the term “may” is indicative that the phrase following the term “may” is an example of one of a multitude of suitable possibilities that may, or may not, be employed to one or more of the various embodiments.

The phrase “a plurality of” followed by a feature, component, or structure is used to mean more than one, specifically including a great many, relative to the context of the component.

It is the applicant's intent that only claims that include the express language “means for” or “step for” be interpreted under 35 U.S.C. § 112. Claims that do not expressly include the phrase “means for” or “step for” are not to be interpreted under 35 U.S.C. § 112.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purpose required by law, but otherwise reserves all copyright rights whatsoever.

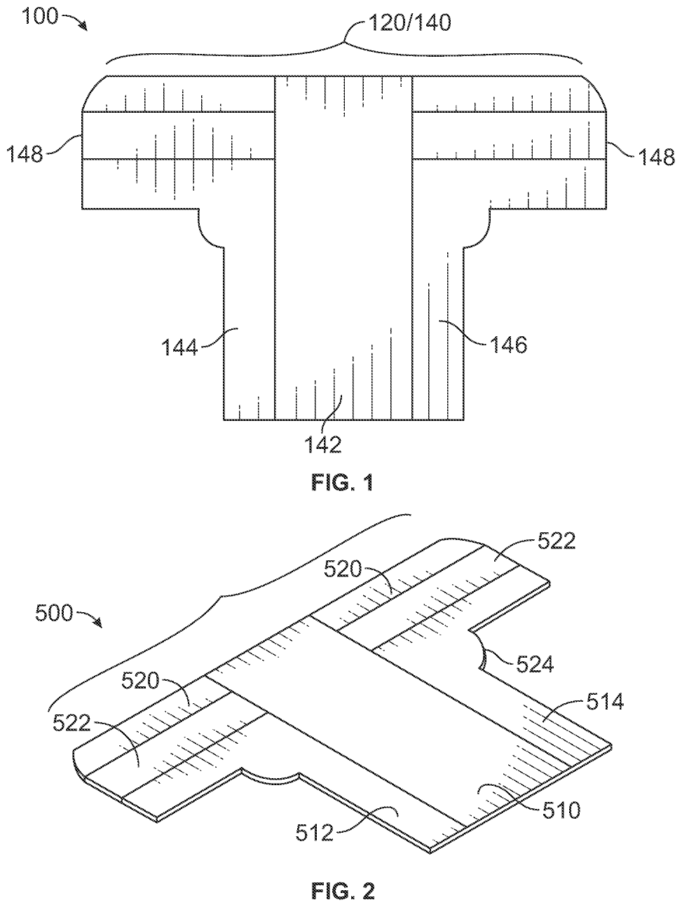

FIG. 1 is a front view of an embodiment of the thin insert 100, showing the formed piece 120. The formed piece 120 of the thin insert 100 has separable pieces 140. The separable pieces 140 primarily include at least one body piece 142, at least one left lateral side portion 144, at least one right lateral side portion 146, and at least two limb pieces 148. These separable pieces 140 join together as the formed piece 120 which internally frames an article, like a t-shirt, as seen in this figure, in a flat orientation and which is thin enough to be incorporated into the dye sublimation process.

FIG. 2 is the rear perspective view of an embodiment of the thin insert, showing an adjustable frame 500 which is primarily comprised of at least one scalable body portion 510, at least one left lateral side portion with a left shoulder portion 512, and at least one lateral side portion with a right shoulder portion 514, and at least two scalable limb portions 520. The at least two scalable limb portions 520 of the adjustable frame 500 further includes two arm sleeve pieces 522 with one armpit expander 524 on each of the two arm sleeve pieces 522. The at least one left lateral side portion with a left shoulder portion 512, and the at least one right lateral side portion with a right shoulder portion 514 are joined together by tongue and groove joints 160 (not visible in the drawing) to form an adjustable frame 500 which is shaped like a t-shirt, and which can be incorporated in the dye sublimation process. Additional left lateral side portion with a left shoulder portion 512, and a right lateral side portion with a right shoulder portion 514 may be attached to the existing left lateral side portion and right lateral side portion to create different sizes frames for differing sizes articles 300 (not visible in the drawing).

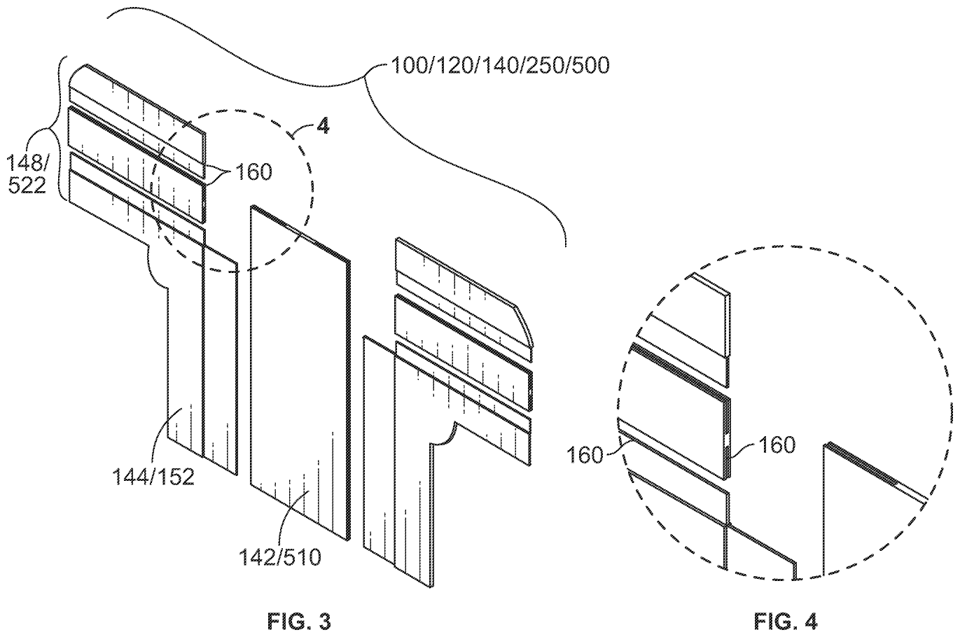

FIG. 4 is an exploded view of a portion of FIG. 3, showing the manner in which the at least two scalable limb portions 520 (not visible in the drawing) are joined with the at least one scalable body portion 510 (not visible in the drawing) by a tongue and groove joint 160 to form the adjustable frame 500 which can be incorporated in the dye sublimation process. The figure also shows the at least two limb pieces 148 (not visible in the drawing) joined with at least one body piece 142 (not visible in the drawing) by a tongue and groove joint 160 to form the formed piece 120 (not visible in the drawing) of the insert 100 (not visible in the drawing).

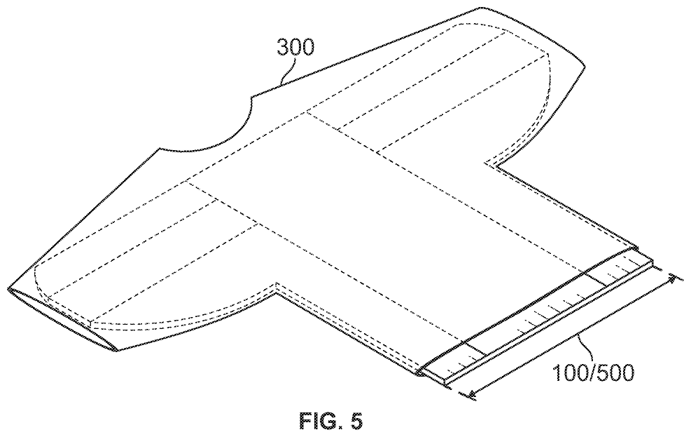

FIG. 5 is an example illustration showing the fully assembled thin insert 100 or the fully assembled adjustable frame 500 being used inside the article 300, which in this figure is a t-shirt.

Thin insert 100 means the overall term to describe the inventive concept, the object which is a flat or has a low profile structure that is introduced between layers of an article 300, like a t-shirt for example, for the purposes of improving the surface of the article for accepting dye or paint. Even the thinnest hair or crease in the fabric will create a glaring break in the dye o the finished product. The thin insert includes a formed piece 120 which is in the shape of the article it is intended to fit. In all embodiments, the thin insert allows for an uninterrupted dye transfer during the dye sublimation process.

Formed Piece 120 is the primary component of the thin insert 100 which internally frames the article in a flat orientation. The orientation of the formed piece 100 is flat relative to the seams/edges along the sides, for a corresponding article in use, such that the article has a front and back. Also, the formed piece is sufficiently thin to be incorporated into the dye sublimation process. This formed piece prevents wrinkles or creases on the article 300. The formed piece is comprised of separable pieces. The separable pieces include at least one body piece, a left lateral side portion, a right lateral side portion, and at least two limb portions. These separable pieces join together, with a tongue and groove joint, as the formed piece to internally frame an article. In some embodiments, the formed piece is made from a lithesome material. Ideal examples of lithesome material can be Aluminum, Torlon, or Polytetrafluroethylene (PTFE). Examples of non-lithesome materials include stone or glass. It cannot be laminate used in kitchen countertops because it is not only short-lived, and easily breaks under the temperature and pressure of the dye sublimation press. This lithesome material, ideally, for this invention can be Polytetrafluroethylene (PTFE), as it can withstand the high temperature and pressure of the dye sublimation press. Polytetrafluoroethylene (PTFE) is a synthetic fluoropolymer which can withstand the high temperature and pressure of the dye sublimation press. PTFE has the following unique properties which makes it one of the ideal materials for use in the dye sublimation press: It is highly dense, thin, durable, flexible, hydrophobic, and is capable of withstanding high temperature and pressure. The thin insert/adjustable frame made of a lithesome material like PTFE can withstand up to 400 F of temperature and up to 70 psi of pressure. The thin insert/adjustable frame made of a pliable material like PTFE is capable of being reused in a dye sublimation press, unlike the single-use forms that are currently being used. The formed piece must be made of a material that is capable of withstanding high temperature and pressures of the dye sublimation press, for many, many uses. It also cannot be made of a stiff or brittle material because the formed piece of the thin insert needs to sufficiently lithesome to allow for the formed piece to be fit in the internal space of the articles without “stretching out” the article for future resale.

Separable Pieces 140 are different joinable pieces which come together as the formed piece. The separable pieces include at least one body piece, a left lateral side portion, a right lateral side portion 146 and at least two limb portions. These separable pieces join together, with a tongue and groove joint, as the formed piece to internally frame an article.

At least one body piece 142 means one of the separable pieces which joins together with the remainder of the separable pieces as the formed piece, which is meant to internally frame the article. The at least one body piece may be specifically structured to cover an upper portion of a body and frame an article like a shirt, t-shirt, or tank top, and which corresponds to the trunk portion of the body which includes sternum and ribs to undergo the process of dye sublimation. This at least one body piece that specifically is structured to cover an upper portion of a body, is used in forming a t-shirt frame to be used in the dye sublimation process. The at least one body piece may also specifically be structured to cover the lower abdominal-pelvic portion of the body, and internally frame an article like a pair of pants, shorts etc. The at least one body piece may also specifically be structured to cover other portions of the body like a forehead, or neck to fit articles like hats, mufflers, scarves etc.

Left lateral side portion 144 means one of the separable pieces which joins together with the remainder of the separable pieces as the formed piece, which is meant to internally frame the article. This left lateral side portion joins on the left side of the at least one body piece to further internally frame the article from the left side. The left side is from the perspective of the onlooker. Additional left lateral side portions may be attached to the existing left lateral side portion to increase the size of the formed piece, so it will fit articles of differing sizes.

Right lateral side portion 146 means one of the separable pieces which joins together with the remainder of the separable pieces as the formed piece, which is meant to internally frame the article. The right lateral side portion joins on the right side of the at least one body piece to further internally frame the article from the right side. The right side is from the perspective of the onlooker. Additional right lateral side portions may be attached to the existing right lateral side portion to increase the size of the formed piece, so it will fit articles of differing sizes.

At least two limb pieces 148 means one of the separable pieces which joins together with the remainder of the separable pieces as the formed piece, which is meant to internally frame the article. The at least two limb pieces may be specifically structured to cover the upper portion of a body and frame articles like a shirt, t-shirt, or tank top, and which corresponds to the sleeve, arm, or hand portion of hands. The at least two limb pieces 148 may be specifically structured to cover the lower portion of a body to frame articles like pants, shorts etc.

Tongue and groove joint 160 means a type of connection that joins the separable pieces as the formed piece together in a structurally sound fashion. A tongue and groove joint means a way of snugly fitting the separable pieces edge to edge, creating a larger, flat formed piece. A tongue and groove connection on different parts of the formed piece, like the at least one body piece or the at least two limb pieces 148, has a long protruding tongue at one longitudinal edge, while the second longitudinal edge has a groove cut to receive the long protruding end of the tongue and together, they interlockingly engage the different parts of the thin insert which is a formed piece. It may also join the at least one scalable body portion 510, the at least one left lateral side portion with a left shoulder portion 512, the at least one right lateral side portion with a right shoulder portion 514, and the at least two scalable limb portions 520 to form an adjustable frame. The tongue and groove joint 160 may also be used to join the armpit expander portion to the arm sleeve portion, or the crotch expander portion to the at least two leg pieces. There are many different types of joints, including: butt joint, miter, half-lap, cross-lap, pocket-hole, tongue and groove, dado, biscuit, mortise and tenon, rabbet, dovetail, half-blind dovetail, sliding dovetail, box, bridle, or finger joint. This specification uses these joint terms in their common meaning to a person having ordinary skill in the art. A tongue-and-groove joint is more effective than the other types of joints because the other types of joints increase the thickness of the thin insert/adjustable frame, or create breaks in the smoothness of the assembled surface that interferes with the transfer of the dye onto the article. Whereas a tongue and groove joint connects various parts of the thin insert/adjustable frame, while not increasing the thickness of the thin insert/adjustable frame. Due to the flatness and thinness created at the connection points, the tongue and groove joint evenly distributes the pressure during dye sublimation process and reduces any size/thickness constraints that other joints pose.

T-Shirt frame shape 250 means the thin insert 100 which is a formed piece to internally frame an article, which is in the shape of a common t-shirt, and which is made by joining the separable pieces which include the at least one body piece, the left lateral side portion, the right lateral side portion, and the at least two limb pieces, with a tongue and groove joint, as the formed piece. This T-shirt frame shape may also be an adjustable frame which is formed by joining the at least one scalable body portion, the at least one left lateral side portion with a left shoulder portion, the at least one right lateral side portion with a right shoulder portion, and at least two scalable limb portions which further include two arm sleeve portions with one armpit expander on each of the two arm sleeve portions, with a tongue and groove joint. This T-shirt frame shape can be inserted within a common t-shirt to be used during the dye-sublimation process.

Article 300 means a range of fabric objects, like clothing or a range of clothing related accessories: t-shirt, pants, scarves, or hats. Article could also mean other types of apparel, home décor items, sports apparel, keep sake items like cell phone cases, mouse pads, dog & cat clothes, or other hard goods that can undergo the dye sublimation process. The thin insert fits in the internal space of the article between different layers of the article, for the purposes of assisting in dye sublimation of the article. The thin insert spreads out the article in a taut/tight and flat manner, so as to avoid any wrinkles on the article, so a design can be applied seam to seam, and cover the entire surface of the article without any interruptions in dye transfer, when the article is in the dye sublimation press, undergoing dye transfer. Some of the embodiments are specific to t-shirts.

Adjustable frame 500 means a modifiable frame which is a thin insert that can scale up or down to increase the size of the thin insert to fit into different sizes and shapes of articles of the same type. An adjustable frame may be used to fit different widths of pants for example, or another might be capable of use for several sizes of shirts by adding and removing portions. The adjustable frame has at least one scalable body portion, at least one left lateral side portion with a left shoulder portion, at least one right lateral side portion with a right shoulder portion, and at least two scalable limb portions. The at least two scalable limb portions include at least two arm sleeve portions, and one armpit expander portion connected to each of the two arm sleeve portions. The at least one scalable body portion, at least one left lateral side portion with a left shoulder portion, at least one right lateral side portion with a right shoulder portion, when connected to the arm pit expander portion and the at least two arm sleeve portions by a tongue and groove connection, create different sizes and shapes of adjustable frames for t-shirts, tank tops, formal shirts, etc. These scalable body and scalable limb portions parts when connected to the crotch expander portion, by way of a joint, like a tongue and groove connection, create different sizes and shapes of adjustable frames for pants, shorts etc. The different portions of the adjustable frame, which is a thin insert, holds an article tight/taut to remove any wrinkles from its surface at the time of dye transfer during the dye sublimation process. It will allow for the dye to transfer smoothly without any breaks and allows the user to print smooth designs from one seam to another seam of the article.

At least one scalable body portion 510 means part of the adjustable frame for an article which covers either the upper body or lower body portion of the article, and which can be scaled up or down in size and shape to accommodate different sizes and shapes of the articles. The scalable body portion could apply for both upper and lower human body. The at least one scalable body portion may be specifically structured to cover an upper portion of a body and frame an article like a shirt, t-shirt, or tank top, and which corresponds to the trunk portion of the body which includes sternum and ribs to undergo the process of dye sublimation. This at least one scalable body portion that specifically is structured to cover an article for the upper portion of a body, is used in forming a t-shirt frame to be used in the dye sublimation process. Though, not seen in the drawings, the neck area of the scalable body portion could have its own expander, similar to the armpit and crotch expander. The at least one scalable body portion may also specifically be structured to cover the lower abdominal-pelvic portion of the body, and internally frame an article like a pair of pants, shorts etc. The at least one scalable body portion may also specifically be structured to cover other portions of the body like a forehead, or neck to fit articles like hats, mufflers, scarves etc.

At least one left lateral side portion with a left shoulder portion 510 means one of the pieces of the adjustable frame which join together with the remainder of the adjustable frame pieces, and which is meant to internally frame the article. The at least one left lateral side portion joins on the left side of the at least one scalable body portion to internally frame the article from the left side. The left side is from the perspective of the user. Additional at least one left lateral side portions may be attached to the existing at least one left lateral side portion to increase the size of the adjustable frame, so it will fit articles of differing sizes.

At least one right lateral side portion with a right shoulder portion 512 means one of the pieces of the adjustable frame which join together with the remainder of the adjustable frame pieces, and which is meant to internally frame the article. The at least one right lateral side portion joins on the right side of the at least one scalable body portion to internally frame the article from the right side. The right side is from the perspective of the user. Additional at least one right lateral side portions may be attached to the existing at least one right lateral side portion to increase the size of the adjustable frame, so it will fit articles of differing sizes.

At least two scalable limb portions 520 means part of the adjustable frame which covers the limb portion of the article, and which can be scaled up or down in size and shape to accommodate different sizes and shapes of the articles. The at least two scalable limb portions cover the arms and/or hands, and can be of different lengths, to cover different sleeve lengths for t-shirts and shirts. This scalable limb portions that covers the arms portion of the upper body, connects with the at least one scalable body portion and an armpit expander with a tongue and groove joint, to create the adjustable frame that is the shape of a shirt. The at least two scalable limb portions may also cover the thighs and/or legs, and can be of different lengths, to cover different pant lengths for pants and shorts. The at least two scalable limb portions that cover the thighs and/or legs portion of the lower body, connects with the at least one scalable body portion and a crotch expander with a tongue and groove joint, to create the adjustable frame that is the shape of pants.

Arm sleeve portion 522 means a part of the at least two scalable limb portions that are meant to internally frame the arm and hand portions of the article.

Armpit Expander 524 means part of the adjustable frame which can expand the armpit area of an adjustable frame which is assembled to be used for different sizes of t-shirts. This armpit expander portion is curved on one end to accommodate the curvature of human armpit. The armpit expander connects to both the at least one scalable body portion which covers the torso region of the upper body and at least two scalable limb portions which cover the arm and/or hand portions of the upper body, with a tongue and groove joint to form an adjustable frame to perform dye sublimation process on different sizes and shapes of shirts.

One embodiment example is a thin insert with a formed piece which can internally frame an article in a flat orientation, and which is sufficiently thin to be incorporated into the dye sublimination process. In this embodiment, the orientation of the thin insert is flat relative to the seams/edges along the sides, such that the article has a front and a back.

A second embodiment example is the thin insert with a formed piece which can internally frame an article which could be a t-shirt, pants, scarf, or hat, and which can be incorporated into the dye sublimation process.

A third embodiment example is the thin insert made from a lithesome formed piece which can frame an article and can be incorporated into the dye sublimation process.

A fourth embodiment example is the thin insert made from a lithesome formed piece, wherein the lithesome material of the formed piece is Polytetrafluoroethylene (PTFE), which can frame an article like a t-shirt, pants, scarf, or hat, and can be incorporated into the dye sublimation process.

A fifth embodiment example is the thin insert made with a lithesome formed piece, wherein the lithesome material of the formed piece is Polytetrafluoroethylene (PTFE). In this embodiment, the formed piece further has separable pieces which further include at least one body piece, a left lateral side portion, a right lateral side portion, and at least two limb pieces. These separable pieces join together as the formed piece to internally frame an article, like a t-shirt, a pair of pants, a scarf, or a hat, and can be incorporated into the dye sublimation process.

A sixth embodiment example is the thin insert of the fifth embodiment wherein the formed piece has separable pieces which further include at least one body piece, a left lateral side portion, a right lateral side portion, and at least two limb pieces. The at least two limb pieces further include two arm sleeve pieces. These arm sleeve pieces have one arm pit piece on each of them. These separable pieces join together as the formed piece to internally frame an article, like a t-shirt, a pair of pants, a scarf, or a hat, and can be incorporated into the dye sublimation process. The article in this embodiment specifically is a t-shirt, and the thin insert is of a t-shirt frame shape.

A seventh embodiment example is the thin insert of the sixth embodiment where the separable pieces are joined together by a tongue and groove joint.

An eighth embodiment example is the thin insert of the sixth embodiment wherein the separable pieces are further scalable by adding additional separable pieces to create an adjustable frame for differing sizes of articles.

A ninth embodiment example is the thin insert made with a lithesome formed piece, wherein the lithesome material of the formed piece is Polytetrafluoroethylene (PTFE). In this embodiment, the formed piece further has separable pieces which further include at least one body piece, a left lateral side portion, a right lateral side portion, and at least two limb pieces. The at least one body piece includes at least one abdominal-pelvic portion. The at least two limb pieces further include at least two leg pieces with one crotch piece. These separable pieces join together as the formed piece to internally frame an article, like a t-shirt, a pair of pants, a scarf, or a hat, and can be incorporated into the dye sublimation process.

A tenth embodiment example is the thin insert of the ninth embodiment where the separable pieces are joined together by a tongue and groove joint.

An eleventh embodiment example is the thin insert of the tenth embodiment wherein the separable pieces are further scalable by adding additional separable pieces to create an adjustable frame for differing sizes of articles.

A twelfth embodiment is an adjustable frame for differing sizes of articles with at least one scalable body portion, at least one left lateral side portion with a left shoulder portion, at least one right lateral side portion with a right shoulder portion, and at least two scalable limb portions. The at least one scalable body portion of this embodiment is joined to the at least two scalable limb portions The at least one scalable body and at least two scalable limb portions include detachable pieces which join together with a tongue and groove joint, to create different sizes frames for differing sizes of articles.

A thirteenth embodiment example is the adjustable frame with at least one scalable body portion, at least one scalable left lateral side portion, at least one scalable right lateral side portion, and at least two scalable limb portions. In this embodiment, the at least one left lateral side portion is an at least one left lateral side portion with a left shoulder portion with tongues on one side that attach into the adjustable frame, and the at least one right lateral side portion is an at least one right lateral side portion with a right shoulder portion with tongues on one side that attach into the adjustable frame, and at least two scalable limb portions which join together with a tongue and groove joint, and is specifically shaped for a scalable t-shirt frame shape. Additional left lateral side portion with a left shoulder portion and right lateral side portion with a right shoulder portion may be attached to the existing left lateral side portion and existing right lateral side portion to create different sizes frames, i.e., adjustable frames, for differing sizes of articles. The at least two scalable limb portion of this embodiment, also includes at least two arm sleeve pieces with one arm pit expander on each arm sleeve piece. The arm pit expander of this embodiment connects its respective arm sleeve piece to the shoulder portion of the scalable body portion and its respective lateral side portion with a tongue and groove joint and is used to create different sizes frames for differing sizes of articles.

A fourteenth embodiment example is the adjustable frame that is specifically shaped for a pair of pants, with at least one scalable body portion, at least one left lateral side portion, at least one right lateral side portion, and at least two scalable limb portions. In this embodiment, the at least one scalable body portion includes at least one abdominal-pelvic portion with grooves on its sides. Additional left lateral side portion and right lateral side portions may be attached to existing left lateral side portion and right lateral side portion to create different sizes frames for differing sizes articles. The at least two scalable limb portion of this embodiment includes at least two leg pieces with one crotch expander. In this embodiment, the crotch expander connects its respective leg piece to the scalable body portion and its respective lateral side portion with a tongue and groove joint.

By example, a method for using the thin insert with a formed piece which can internally frame an article and which can be used with a dye sublimination press, comprising the steps of: creating the mirror image of the image that needs to be incorporated on the article, setting up the image that needs to be incorporated on the article on a computer, loading the sublimation press with aqueous ink, heating up the sublimation press to a required temperature, placing the insert inside the blank article, stretching the article on the sufficiently thin insert to remove any wrinkles, placing the article inside the sublimation press with the print side down, closing the sublimation press to transfer the image on to the article, exposing the article and the thin insert to high temperature and pressure to undergo dye sublimation process, manually opening the sublimation press to retrieve the finished article from the press, and separating the thin insert from the article which now has the right side up image printed on it.

By example, a method for using the adjustable frame with the dye sublimation frame, comprising the steps of: creating the mirror image of the image that needs to be incorporated on the article, setting up the image that needs to be incorporated on the article on a computer, loading the sublimation press with aqueous ink, heating up the sublimation press to a required temperature, attaching the at least one scalable body portion, the at least one left lateral side portion with a left shoulder portion, at least one right lateral side portion with a right shoulder portion to at least two scalable limb portions with a tongue and groove connection to create an adjustable frame, attaching the adjustable frame to the insert, placing the insert inside the blank article, stretching the article on the sufficiently thin insert to remove any wrinkles, placing the article inside sublimation press with the print side down, closing the sublimation press to transfer the image on to the article, exposing the article and the sufficiently thin insert to high temperature and pressure to undergo dye sublimation process, manually opening the sublimation press to retrieve the finished article from the press, and separating the insert from the article which now has the right side up image printed on it.

By example, a method of using the adjustable frame, with the armpit expander portion, compromising the steps of: creating the mirror image of the image that needs to be incorporated on the article, setting up the image that needs to be incorporated on the article on a computer, loading the sublimation press with aqueous ink, heating up the sublimation press to a required temperature, attaching the scalable body portion including at least one left lateral side portion with a left shoulder portion, at least one right lateral side portion with a right shoulder portion, to the at least two scalable limb portions including at least two arm sleeve pieces with one arm pit expander on each arm sleeve piece, with a tongue and groove joint, to create an adjustable frame, attaching the adjustable frame to the insert, placing the insert inside the blank article, stretching the article on the sufficiently thin insert to remove any wrinkles, placing the article inside the sublimation press with the print side down, closing the sublimation press to transfer the image on to the article, exposing the article and the sufficiently thin insert to high temperature and pressure to undergo dye sublimation profess, manually opening the sublimation press to retrieve the finished article from the press, and separating the insert from the article which now has the right side up image printed on it.

By example, a method of using the adjustable frame, with the crotch expander portion, compromising the steps of: creating the mirror image of the image that needs to be incorporated on the article, setting up the image that needs to be incorporated on the article on a computer, loading the sublimation press with aqueous ink, heating up the sublimation press to a required temperature, attaching the at least one scalable body portion including at least one abdominal-pelvic portion, at least one left lateral side portion, and at least one right lateral side portion, to at least two scalable limb portions including at least two leg pieces with one crotch expander, with a tongue and groove connection, attaching the crotch expander portion between the at least one scalable body portion and at least two scalable limb portions with a tongue and groove connection, creating the adjustable frame, attaching the adjustable frame to the insert, placing the insert inside the blank article, stretching the article on the sufficiently thin insert to remove any wrinkles, placing the article inside the sublimation press with the print side down, closing the sublimation press to transfer the image on to the article, exposing the article and the sufficiently thin insert to high temperature and pressure to undergo dye sublimation process, manually opening the sublimation press to retrieve the finished article from the press, and separating the insert from the article which now has the right side up image printed on it.

What is claimed is:

1. A thin insert to internally frame an article, comprising:
a formed piece internally frames the article in a flat orientation;
the formed piece keeps the flat orientation of the article during a dye sublimation process; and
the formed piece is sufficiently thin to incorporate into the dye sublimation process.

2. The thin insert of claim 1, is the thin insert internally frames an article, which is one of: a t-shirt, a pair of pants, a scarf, or a hat.

3. The thin insert of claim 2 is made from a lithesome material.

4. The thin insert of claim 3, wherein the lithesome material of the formed piece is polytetrafluoroethylene (PTFE).

5. The thin insert of claim 4 wherein the formed piece further comprises:
separable pieces;
the separable pieces include at least one body piece, a left lateral side portion; a right lateral side portion, and at least two limb pieces; and
the separable pieces join together as the formed piece to internally frame a t-shirt.

6. The thin insert of claim 5, wherein the formed piece further comprises:
separable pieces;
the separable pieces include at least one body piece, a left lateral side portion; a right lateral side portion, and at least two limb pieces;
the at least two limb pieces include at least two arm sleeve pieces with one arm pit piece on each of the at least two arm sleeve pieces; and
the separable pieces join together as the formed piece to internally frame a t-shirt.

7. The thin insert of claim 5, wherein the separable pieces join together in a tongue and groove joint.

8. The thin insert of claim 5, wherein the separable pieces are further scalable by adding additional separable pieces to create an adjustable frame for different sizes of t-shirts.

9. The thin insert of claim 4, wherein the formed piece further comprises:
separable pieces;
the separable pieces include at least one body piece, at least one abdominal-pelvic portion, a left lateral side portion; a right lateral side portion, and at least two limb pieces;
the at least two limb pieces include at least two leg pieces with one crotch piece; and
the separable pieces join together as the formed piece to internally frame a pair of pants.

10. The thin insert of claim 9, wherein the separable pieces join together in a tongue and groove joint.

11. The thin insert of claim 9, wherein the separable pieces are further scalable by adding additional separable pieces to create an adjustable frame for differing sizes of articles.

12. An adjustable frame for differing sizes articles comprises:
at least one scalable body portion, at least one left lateral side portion, at least one lateral side portion, and at least two scalable limb portion, where the at least one scalable body portion and the at least two scalable limb portion join with a tongue and groove joint; and
the at least one scalable body and the at least two scalable limb portions are detachable pieces used to create different sizes frames for differing sizes of articles.

13. The adjustable frame of claim 12, wherein the at least one scalable body portion, at least one left lateral side portion, at least one right lateral side portion, and the at least two scalable limb portions are specifically shaped for a scalable T-shirt;
the at least one left lateral side portion is an at least one left lateral side portion with a left shoulder portion, and the at least one right lateral side portion is an at least one lateral side portion with a right shoulder portion;
the left lateral side portion with a left shoulder portion and a right lateral side portion with a right shoulder portion have tongues on one side that attach into the adjustable frame;
additional left lateral side portion with a left shoulder portion and right lateral side portion with a right shoulder portion may be attached to the existing left lateral side portion and a right lateral side portion to create different sizes frames for differing sizes of articles;
the at least two scalable limb portion includes at least two arm sleeve pieces with one armpit expander on each arm sleeve piece; and
the armpit expander connects its respective arm sleeve piece to the shoulder portion of the scalable body portion and its respective lateral side portion with a tongue and groove joint and are used to create different sizes frames for differing sizes of articles in order to maintain stability of the article for painting, pressing, or dying processes.

14. The adjustable frame of claim 12, wherein the at least one scalable body portion, the at least one left lateral side portion, the at least one right lateral side portion, and the at least two scalable limb portions are specifically shaped for a pair of pants;
the at least one scalable body portion includes at least one abdominal-pelvic portion with grooves on its sides;
the left lateral side portion and a right lateral side portion have tongues on one side that attach into the adjustable frame to increase the size of the scalable body portion as needed;
additional left lateral side portion and right lateral side portion may be attached to the existing left lateral side portion and a right lateral side portion to create different sizes frames for differing sizes of articles;
the at least two scalable limb portion includes at least two leg pieces with one crotch expander; and
the crotch expander connects its respective leg piece to the scalable body portion and its respective lateral side portion with a tongue and groove joint and are used to create different sizes frames for differing sizes of articles in order to maintain stability of the article for painting, pressing, or dying processes.

15. A method for using the adjustable frame from claim 12, with dye sublimation press, compromising the steps of:
creating the mirror image of the image that needs to be incorporated on the article;
setting up the image that needs to be incorporated on the article on a computer;
loading the sublimation press with aqueous ink;
heating up the sublimation press to a required temperature;
attaching the at least one scalable body portion and at least two scalable limb portions with a tongue and groove connection to create an adjustable frame;
attaching the adjustable frame to the thin insert;
placing the thin insert inside the blank article;
stretching the article on the thin insert to remove any wrinkles to avoid disruptions in the dye transfer process;
placing the article inside sublimation press with the print side down;
closing the sublimation press to transfer the image on to the article;
exposing the article and the sufficiently thin insert to high temperature and pressure to undergo dye sublimation process;
manually opening the sublimation press to retrieve the finished article from the press; and
separating the insert from the article which now has the right side up image printed on it.

16. The method of using the adjustable frame from claim 15, compromising the additional steps of:
attaching necessary number of left lateral side portions with a left shoulder portion and right lateral side portions with a right shoulder portion to the existing left lateral side portion with a left shoulder portion and a right lateral side portion with a right shoulder portion with tongue and groove joints to create the requisite sizes scalable body portion;
attaching the scalable limb portion with at least two arm sleeve pieces containing one armpit expander on each arm sleeve piece to create the requisite sizes scalable limb portion;
attaching the at least one scalable body portion and at least two scalable limb portions with a tongue and groove connection to create an adjustable frame;
attaching the adjustable frame to the thin insert;
repeating steps from claim 15.

17. The method of using the adjustable frame from claim 15, compromising the additional steps of:
attaching necessary number of left lateral side portions and right lateral side portions to the existing left lateral side portion and a right lateral side portion with tongue and groove joints to create the requisite sizes scalable body portion;
attaching the scalable limb portion with at least two leg pieces containing one crotch expander piece to create the requisite sizes scalable limb portion;
attaching the at least one scalable body portion and at least two scalable limb portions with a tongue and groove connection to create an adjustable frame;
repeating steps from claim 15.
